(19) United States
(12) Patent Application Publication
(10) Pub. No.: US 2016/0283006 A1
(43) Pub. Date: Sep. 29, 2016

(54) PRESSURE SENSOR INCLUDING TIME-DOMAIN REFLECTOMETER

(71) Applicant: Panasonic Intellectual Property Management Co., Ltd., Osaka (JP)

(72) Inventors: TETSUYOSHI OGURA, Osaka (JP); Kenichi Ezaki, Osaka (JP); Keiji Noine, Osaka (JP); Shinobu Masuda, Osaka (JP)

(21) Appl. No.: 15/074,887

(22) Filed: Mar. 18, 2016

(30) Foreign Application Priority Data
Mar. 24, 2015 (JP) 2015-061374

(51) Int. Cl. G06F 3/041; G06F 3/044

(52) U.S. Cl. CPC G06F 3/0414; G06F 3/044; G06F 2203/04112; G06F 2203/04107; G06F 2203/04106

(57) ABSTRACT

A pressure sensor according to one aspect of the present disclosure includes a first dielectric layer that has elasticity and has a first surface and a second surface which is on an opposite side from the first surface, a first conductor layer that is arranged on at least a region of the first surface, a second conductor layer that is arranged on the second surface, and a first time-domain reflectometer that is connected with the first conductor layer and the second conductor layer, and the region of the first surface is opposed to the second conductor layer.

### BACKGROUND

1. Technical Field

The present disclosure relates to a pressure sensor and a pressure sensing device such as a touch panel or a switch that incorporates the pressure sensor.

2. Description of the Related Art

In recent years, operating apparatuses and pressure sensors that detect contact of a finger or the like have been widely used with the spread of portable apparatuses such as smart phones. However, there has been a problem about malfunction in capacitive type touch panels and capacitive type switches of those apparatuses. Specifically, there has been a problem that the capacitive type touch panel or switch recognizes an only approaching finger or only soft contact as a touch or a pressing operation and detects contact although an operator him/herself has no intention of touching or pressing and thereby causes an operation of the apparatus that is not intended by the operator him/herself.

Further, there have been problems that those capacitive type touch panel and switch have difficulty in bending and stretching and that the cost increases due to long leader wires because a certain capacitance has to be formed or multiple wires are formed in X and Y directions.

In consideration of such problems, Japanese Unexamined Utility Model Registration Application Publication No. 5-4254 discloses a method in which an input device has meander-shaped wires formed on a screen surface and a contact position of a finger with the meander-shaped wires is measured as a capacitance change from a grounded GND by time domain reflectometry (hereinafter abbreviated as TDR) method.

Further, Japanese Unexamined Patent Application Publication No. 2011-89923 discloses a method in which a sensor has coils wound on an elastic supporting body, the deformation in accordance with the extension of the elastic supporting body is regarded as an impedance change of the coils and measured by using the TDR method, and the magnitude and position of the extension deformation is thereby detected.

### SUMMARY

In one general aspect, the techniques disclosed here feature a pressure sensor including; a first dielectric layer that has elasticity and has a first surface and a second surface which is on an opposite side from the first surface; a first conductor layer that is arranged on at least a region of the first surface; a second conductor layer that is arranged on the second surface; and a first time-domain reflectometer that is connected with the first conductor layer and the second conductor layer, in which the region of the first surface is opposed to the second conductor layer.

A pressure sensor of the present disclosure may detect a position of contact and a magnitude of pressure due to contact without causing a malfunction although having an easy structure.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic cross-sectional view of a pressure sensor for explaining a detection principle of a pressure sensor of the present disclosure;

FIG. 2A is a diagram that illustrates an operation state for explaining the detection principle of the pressure sensor of the present disclosure;

FIG. 2B is a diagram that illustrates the operation state for explaining the detection principle of the pressure sensor of the present disclosure;

FIG. 2C is a diagram that illustrates the operation state for explaining the detection principle of the pressure sensor of the present disclosure;

FIG. 3A is a perspective view of a pressure sensor according to a first embodiment of the present disclosure;

FIG. 3B is a schematic cross-sectional view of IIIB-IIIB cross section of the pressure sensor according to the first embodiment of the present disclosure as seen in the arrow direction;

FIG. 3C is a schematic cross-sectional view of IIIC-IIIC cross section of the pressure sensor according to the first embodiment of the present disclosure as seen in the arrow direction;

FIG. 3D is a circuit configuration diagram in a case where a pressure is detected by using the pressure sensor according to the first embodiment of the present disclosure;

FIG. 4A is a graph that represents a change in voltage over time in a case where a pressure is not applied in the pressure sensor according to the first embodiment of the present disclosure;

FIG. 4B is a graph that represents the change in voltage over time in a case where a pressure is applied to a specific place in the pressure sensor according to the first embodiment of the present disclosure;

FIG. 4C is a graph that represents the change in voltage over time in a case where a different pressure is applied to the same place as FIG. 4B in the pressure sensor according to the first embodiment of the present disclosure;

FIG. 4D is a graph that represents the change in voltage over time in a case where the same pressure is applied to a different place from FIG. 4B in the pressure sensor according to the first embodiment of the present disclosure;

FIG. 5A is a perspective view of a pressure sensor according to a second embodiment of the present disclosure;

FIG. 5B is a schematic cross-sectional view of VB-VB cross section of the pressure sensor according to the second embodiment of the present disclosure as seen in the arrow direction;

FIG. 5C is a schematic cross-sectional view of VC-VC cross section of the pressure sensor according to the second embodiment of the present disclosure as seen in the arrow direction;

FIG. 5D is a circuit configuration diagram in a case where a pressure is detected by using the pressure sensor according to the second embodiment of the present disclosure;

FIG. 6A is a schematic diagram of a third conductor layer of the pressure sensor according to the second embodiment of the present disclosure;

FIG. 6B is a schematic diagram of a second conductor layer of the pressure sensor according to the second embodiment of the present disclosure;

FIG. 7A is a schematic cross-sectional view of a pressure sensor according to a third embodiment of the present disclosure;

FIG. 7B is a schematic cross-sectional view of a pressure sensor according to the third embodiment of the present disclosure;

FIG. 8A is a perspective view of a pressure sensor according to a fourth embodiment of the present disclosure and is a perspective view of the pressure sensor from which portions of a shield layer and a shield layer forming dielectric layer are removed;

FIG. 8B is a schematic cross-sectional view of VIIIB-VIIIB cross section of the pressure sensor according to the fourth embodiment of the present disclosure as seen in the arrow direction;

FIG. 8C is a schematic cross-sectional view of VIIIC-VIIIC cross section of the pressure sensor according to the fourth embodiment of the present disclosure as seen in the arrow direction;

FIG. 9A is a schematic cross-sectional view of a pressure sensor according to a fifth embodiment of the present disclosure;

FIG. 9B is a schematic cross-sectional view of the pressure sensor according to the fifth embodiment of the present disclosure;

FIG. 10A is a top view of a pressure sensor according to a sixth embodiment of the present disclosure;

FIG. 10B is a schematic cross-sectional view of XB-XB cross section of the pressure sensor according to the sixth embodiment of the present disclosure as seen in the arrow direction;

FIG. 11 is a sketch that illustrates one example of a shape of the pressure sensing device that uses the pressure sensor of the present disclosure;

FIG. 12 is a sketch that illustrates one example of the shape of the pressure sensing device that uses the pressure sensor of the present disclosure;

FIG. 13A is a sketch that illustrates one example of the shape of the pressure sensing device that uses the pressure sensor of the present disclosure;

FIG. 13B is a sketch that illustrates one example of the shape of the pressure sensing device that uses the pressure sensor of the present disclosure;

FIG. 14 is a sketch that illustrates one example of the shape of the pressure sensing device that uses the pressure sensor of the present disclosure; and

FIG. 15 is a sketch that illustrates one example of the shape of the pressure sensing device that uses the pressure sensor of the present disclosure.

### DETAILED DESCRIPTION

The present inventors have found as a result of intensive studies that a pressure sensor in related art has room for improvement in the following points,

The method disclosed in Japanese Unexamined Utility Model Registration Application Publication No. 5-4254 has: a problem that the magnitude of pressure by contact may not be detected because the capacitance to ground is detected; a problem that the pressure sensor is subject to the influence of disturbance and the sensitivity is impaired because a shield layer may not be provided on a surface layer in order to detect the capacitance to ground; and a problem that a higher frequency is desired for increasing the position detection accuracy in the wire direction of the meander-shaped wires and the device becomes expensive; and so forth.

The method disclosed in Japanese Unexamined Patent Application Publication No. 2011-89923 has: a problem that the stretching may be detected but the magnitude of pressure may not be detected; a problem that a support member with wound coils has to be arranged in the meander shape on a flat plate in order to allow the pressure sensor to have a flat configuration such as a touch screen, thus increasing the cost; a problem that the detection sensitivity is subject to the influence of disturbance and is impaired; a problem that it is difficult to make the pressure sensor transparent due to a complicated shape; and so forth.

The present disclosure provides a pressure sensor that may detect a position of contact and a magnitude of pressure due to contact without causing a malfunction although having an easy structure.

A pressure sensor according to one aspect of the present disclosure is a pressure sensor including: a first dielectric layer that has elasticity and has a first surface and a second surface which is on an opposite side from the first surface; a first conductor layer that is arranged on at least a region of the first surface; a second conductor layer that is arranged on the second surface; and a first time-domain reflectometer that is connected with the first conductor layer and the second conductor layer, in which the region of the first surface is opposed to the second conductor layer. In the pressure sensor according to one aspect of the present disclosure, the second conductor layer may have a linear shape,

In the pressure sensor according to one aspect of the present disclosure, the first conductor layer may have a mesh shape or a sheet shape.

In the pressure sensor according to one aspect of the present disclosure, in operation, the first time-domain reflectometer may input a first signal to the first conductor layer and the second conductor layer when a stress from an outside is applied to at least a portion of the first dielectric layer and measure a magnitude of a first reflected wave that is generated by reflection of the first signal by the at least portion of the first dielectric layer and a first reflection time that is a time from the input of the first signal to the first conductor layer and the second conductor layer to arrival of the first reflected wave to the first time-domain reflectometer. In the pressure sensor according to one aspect of the present disclosure, in operation, the first time-domain reflectometer may detect at least one selected from the group of a magnitude of the stress and a position of the at least portion of the first dielectric layer based on the magnitude of the first reflected wave and the first reflection time.

In the pressure sensor according to one aspect of the present disclosure, the first time-domain reflectometer may include: a first signal input device that, in operation, inputs a first signal to the first conductor layer and the second conductor layer; a first reflected wave detection device that, in operation, detects a first reflected wave that is generated by reflection of the first signal by at least a portion of the first dielectric layer; and a first reflection time measurement device that, in operation, measures a first reflection time that is a time from an input of the first signal to the first conductor layer and the second conductor layer to arrival of the first reflected wave to the first time-domain reflectometer, each of the first signal input device and the first reflected wave detection device may be connected with the first conductor layer and the second conductor layer, and the first reflection time measurement device may be connected with the first reflected wave detection device. In the pressure sensor according to one aspect of the present disclosure, the first time-domain reflectometer may further include a processor that, in operation, obtain at least one selected from the group of a magnitude of the stress and a position of the at least portion of the first dielectric layer based on the magnitude of the first reflected wave and the first reflection time.

In the pressure sensor according to one aspect of the present disclosure, the first conductor layer may cover a whole surface of the first surface, and the second conductor layer may have a meander shape.

The pressure sensor according to one aspect of the present disclosure may further include: a second dielectric layer that is arranged on the second conductor layer and on the second surface of the first dielectric layer and has elasticity, and a shield layer that is arranged on the second dielectric layer and has conductivity.

The pressure sensor according to one aspect of the present disclosure may further include: a second dielectric layer that is arranged on the second conductor layer and on the second surface of the first dielectric layer and has elasticity; and a third conductor layer that is arranged on the second dielectric layer. In the pressure sensor according to one aspect of the present disclosure, the third conductor layer may have a linear shape.

In the pressure sensor according to one aspect of the present disclosure, the second conductor layer and the third conductor layer may have meander shapes.

In the pressure sensor according to one aspect of the present disclosure, the second conductor layer may include first straight line portions that extend in a first direction and first connectors that are shorter than each of the first straight line portions, each of the first connectors may connect ends of two neighboring first straight line portions of the first straight line portions, the third conductor layer may include second straight line portions that extend in a second direction which is different from the first direction and second connectors that are shorter than each of the second straight line portions, and each of the second connectors may connect ends of two neighboring second straight line portions of the second straight line portions.

The pressure sensor according to one aspect of the present disclosure may further include a second time-domain reflectometer that is connected with the first conductor layer and the third conductor layer.

In the pressure sensor according to one aspect of the present disclosure, the second time-domain reflectometer may include: a second signal input device that, in operation, inputs a second signal to the first conductor layer and the third conductor layer; a second reflected wave detection device that, in operation, detects a second reflected wave that is generated by reflection of the second signal by at least a portion of the first dielectric layer and the second dielectric layer; and a second reflection time measurement device that, in operation, measures a second reflection time that is a time from an input of the second signal to the first conductor layer and the third conductor layer to arrival of the second reflected wave to the second time-domain reflectometer, each of the second signal input device and the second reflected wave detection device may be connected with the first conductor layer and the third conductor layer, and the second reflection time measurement device may be connected with the second reflected wave detection device.

The pressure sensor according to one aspect of the present disclosure may further include a switch that is arranged between the first time-domain reflectometer and the second conductor layer and switches states between a state where the first time-domain reflectometer is connected with the second conductor layer and a state where the first time-domain reflectometer is connected with the third conductor layer.

The pressure sensor according to one aspect of the present disclosure may further include; a third dielectric layer that is arranged on the third conductor layer and on the second dielectric layer on which the third conductor layer is arranged and has elasticity; and a shield layer that is arranged on the third dielectric layer and has conductivity,

The pressure sensor according to one aspect of the present disclosure may further include a shield layer that is arranged in the second dielectric layer and has conductivity.

In the pressure sensor according to one aspect of the present disclosure, at least one selected from the group of the first conductor layer and the second conductor layer may include indium tin oxide.

In the pressure sensor according to one aspect of the present disclosure, the first dielectric layer may include a transparent resin.

### [Pressure Sensor]

A pressure sensor of the present disclosure is a detector that may detect the position of contact and the magnitude of a contact pressure by using at least one linear wire as one conductor layer.

In a description made below, a pressure sensor according to embodiments of the present disclosure will be described with reference to drawings. Note that various elements and members illustrated in the drawings are only schematically illustrated for understanding of the present disclosure and dimension ratios, external appearances, and so forth may be different from actual articles. “Up-down direction” that is directly or indirectly used herein corresponds to the direction that corresponds to the up-down direction in the drawings. Further, the same reference characters and symbols represent the same members and same meanings and contents except differences in shape unless otherwise noted.

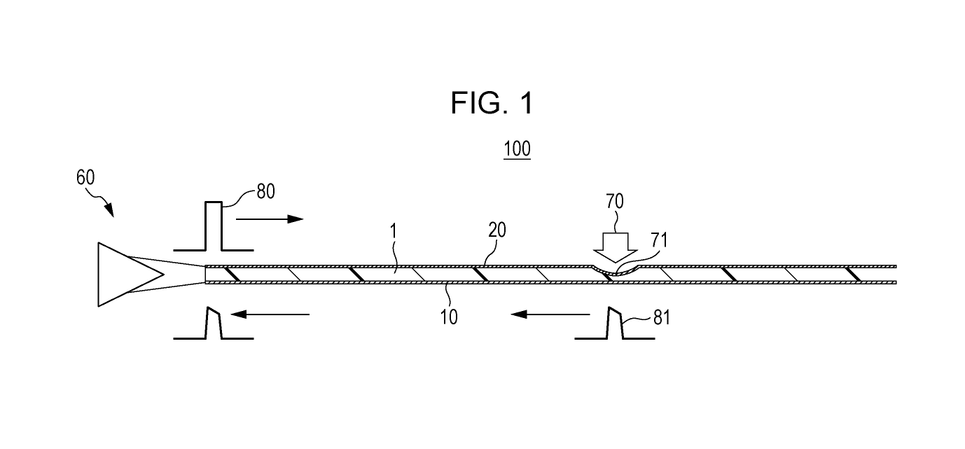

The pressure sensor of the present disclosure generates a reflected wave by elastic deformation of a dielectric layer due to a stress from the outside, measures the reflected wave, and thereby detects the position of deformation by contact and the magnitude of contact pressure, based on time domain reflectometry method (hereinafter simply referred to as “TDR method”). The detection principle of the pressure sensor of the present disclosure will be described with reference to FIG. 1.

FIG. 1 is a cross-sectional view that schematically illustrates a pressure sensor 100 of one aspect of the present disclosure. The pressure sensor 100 of the present disclosure includes a dielectric layer 1, a first conductor layer 10, a second conductor layer 20, and a time-domain reflectometer 60.

In the pressure sensor 100 of the present disclosure, the dielectric layer 1 is formed of an elastic body, a first conductor layer 10 and a second conductor layer 20 are respectively formed on different surfaces of the dielectric layer 1. The second conductor layer 20 is formed as a linear wire, and the first conductor layer 10 is formed at least in a region that is opposed to a formation region of the second conductor layer 20. Such first conductor layer 10 and second conductor layer 20 are connected with the time-domain reflectometer 60.

In such a pressure sensor 100, a signal 80 is input from the time-domain reflectometer 60 to the first conductor layer 10 and the second conductor layer 20 such that a prescribed voltage is applied, and the reflected wave that occurs in an elastic deformation portion 71 which is an impedance mismatching portion may thereby be measured. That is, a reflected wave 81 may be generated based on the elastic deformation portion 71 of the dielectric layer 1 due to a stress 70 from the outside. The reflected wave 81 may be observed with a fluctuation in voltage in a case where the time-domain reflectometer 60 measures the change in voltage over time. The fluctuation range of the fluctuation in voltage is measured as the magnitude of the reflected wave, the time from the application of the voltage to the fluctuation (the time in which the reflected wave 81 returns (reflection time)) is further measured, and the position of deformation by contact and the magnitude of contact pressure may thereby be detected.

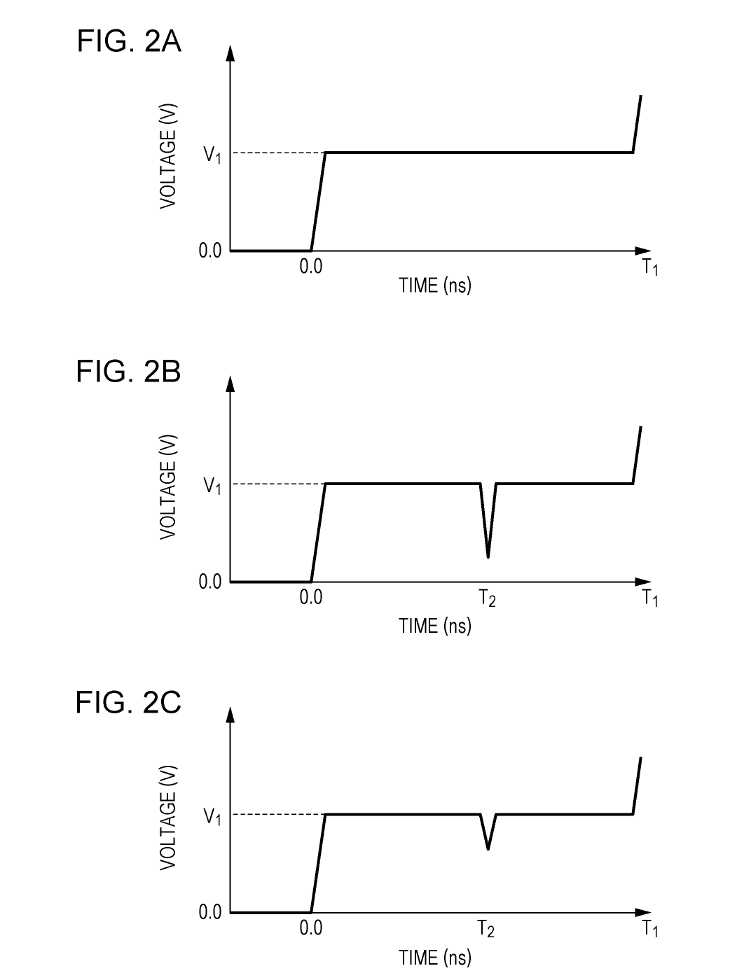

The change in voltage over time will specifically be described with reference to FIGS. 2A to 2C. FIG. 2A is a graph in a case where no stress is applied to the pressure sensor 100. FIG. 2B is a graph in a case where a stress of F₁ is applied to a portion X at a distance L₁/2 from the connection portion between the second conductor layer 20 with a total length L₁ and the time-domain reflectometer 60. FIG. 2C is a graph in a case where a stress of F₁/2 is applied to the same portion X as the above in the second conductor layer 20.

In FIG. 2A, because no stress is applied, the thickness of the dielectric layer 1 does not change. Thus, the distance between the second conductor layer 20 and the first conductor layer 10 may be considered as a transmission line having a regular impedance in every portion of the second conductor layer 20. Accordingly, in a case where a signal is input from the time-domain reflectometer 60 such that a voltage of V₁ is applied at a time 0, the time-domain reflectometer 60 may measure the voltage of V₁ from the time 0 to a time T₁. The voltage exhibits a higher value than V₁ at the time T₁ because a signal reflected by an end of the second conductor layer 20 on the opposite side from the connection portion with the time-domain reflectometer 60 is measured.

The fact that the reflected wave may be observed at the time T₁ means that the time necessary for an electric signal to travel back and forth over a length L₁ of the second conductor layer 20 is the time T₁. Such a time T₁ that is necessary for the electric signal to travel back and forth is determined by the dielectric constant and thickness of the dielectric layer 1, the wire width of the second conductor layer 20, and so forth.

Next, in a case where the stress of F₁ is vertically applied to the portion X at the distance L₁/2 from the connection portion in the second conductor layer 20 with the time-domain reflectometer 60, the dielectric layer 1 deforms due to the stress, and the thickness decreases. Thus, the distance between the second conductor layer 20 and the first conductor layer 10 becomes shorter, and the capacitance of this portion increases. This indicates that the impedance lowers, and the reflected wave is generated in this impedance mismatching portion.

A graph that represents the situation is FIG. 2B. The lowered voltage at a time T₂ indicates generation of the reflected wave. The time T₂ represents half the time T₁ of FIG. 2A (T₂=T₁/2). Thus it may be understood that a stress is applied to a point at the distance L₁/2 from the connection portion in the second conductor layer 20 with the time-domain reflectometer 60.

Further, a graph in a case where the stress of F₁/2 is applied to the same portion X as FIG. 2B is FIG. 2C. It may be understood that the decrease amount of voltage is small compared to FIG. 2B. As described above, an applied stress may be measured by measuring the fluctuation range of voltage.

A description will be made about members that configure the pressure sensor 100 of the present disclosure.

The dielectric layer 1 is formed of an elastic body that has an “elastic characteristic”. The “elastic characteristic” is a characteristic that an object locally deforms due to external force and returns to an original shape when the force is removed. It is sufficient that the dielectric layer 1 has an elastic modulus at which the dielectric layer 1 is elastically deformable by usual pressing force applied to the pressure sensor 100 (for example, pressing force of approximately 1 to 10 N), and the dielectric layer 1 may have an elastic modulus of approximately 10⁴ to 10¹⁰ Pa, for example.

The dielectric layer 1 may be formed of any material as long as the dielectric layer 1 has properties of a “dielectric” and the above “elastic characteristic”. For example, the dielectric layer 1 may be configured to contain a polymer material such as a silicone resin (such as poly(dimethylsiloxane) (PDMS), for example), a styrene-based resin, an acrylic resin, and a rotaxane-based resin. The elastic modulus may be adjusted by changing the degree of polymerization and/or the degree of cross-linkage of a polymer material.

It is sufficient that the thickness of the dielectric layer 1 is a thickness with which the dielectric layer 1 is elastically deformable in a usual pressing force range.

The dielectric layer 1 may be obtained by cutting a polymer material that is synthesized in advance by a known method. Further, the dielectric layer 1 may be formed by a formation method of a polymer layer, which is commonly used in the field of electronics packaging.

The first conductor layer 10 is a conductor layer formed on one surface of the dielectric layer 1 and may be formed of any material as long as the first conductor layer 10 has conduction characteristics that allow a so-called electrode to be configured in the field of capacitive type pressure sensor. Examples of materials for configuring the first conductor layer 10 may include copper, aluminum, silver, stainless steel, indium tin oxide (ITO), and so forth.

The first conductor layer 10 may be a shield layer that has a shield function for blocking an electromagnetic and/or electrostatic interference (noise) from the outside. The first conductor layer 10 may be a so-called ground layer.

The first conductor layer 10 may be formed into any shape as long as the first conductor layer 10 is formed at least in the region that is opposed to the formation region of the second conductor layer 20. The region that is opposed to the formation region of the second conductor layer 20 is a region of the one surface of the dielectric layer 1, which corresponds to a portion directly under the formation region of the second conductor layer 20 that is formed on the other surface of the dielectric layer 1 and will be described later. It is sufficient that the first conductor layer 10 is formed at least in such a corresponding region. The first conductor layer 10 may be formed into a mesh in which sieve openings as in a net are provided or may be formed into a sheet in which the sieve openings are filled (that is, a configuration material is present on a substantially whole surface of a prescribed region), for example. The first conductor layer 10 having such a shape usually has the shield function.

The first conductor layer 10 may be formed on whole a surface of the dielectric layer 1. The first conductor layer 10 is usually formed on whole the surface of the dielectric layer 1. However, the first conductor layer 10 may not necessarily be formed on whole the surface of the dielectric layer 1 in accordance with a circumstance of formation of the second conductor layer 20 on the other surface of the dielectric layer 1. For example, in a case where a non-formation region portion in which no second conductor layer 20 is formed is present on the other surface of the dielectric layer 1, the first conductor layer 10 may be formed in a region portion that corresponds to a portion directly under the non-formation region portion or may not be formed.

The thickness of the first conductor layer 10 is not particularly limited as long as detection of the reflected wave by the TDR method is possible.

The first conductor layer 10 may be formed on the surface of dielectric layer 1 by a plating method, a bonding method, or the like. A second conductor layer, a third conductor layer, and the shield layer, which will be described later, may be formed by similar methods. The plating method is used as a concept that includes a dry plating method and a wet plating method. Examples of the dry plating method may include: vacuum plating methods (PVD methods) such as a spattering method, a vacuum evaporation method, and an ion plating method; and chemical vapor plating methods (CVD methods). Examples of the wet plating method may include: electric plating methods such as electroplating methods; chemical plating methods; and hot-dip plating methods. The dry plating method, for example, the spattering method, may be used as the plating method. The bonding method is a method in which the first conductor layer 10 formed in advance is attached to the surface of the dielectric layer 1 by an adhesive.

The second conductor layer 20 is a conductor layer that is formed as a linear wire on the other surface of the dielectric layer 1. The second conductor layer 20 may be formed of any material as long as the second conductor layer 20 has conduction characteristics that allow a so-called electrode to be configured in the field of capacitive type pressure sensor. Examples of materials for configuring the second conductor layer 20 may include copper, aluminum, silver, stainless steel, ITO, and so forth.

The wire width of the second conductor layer 20 is not particularly limited as long as detection of the reflected wave by the TDR method is possible. The wire length of the second conductor layer 20 may appropriately be set in accordance with the broadness of a desired sensor region.

The thickness of the second conductor layer 20 is not particularly limited as long as detection of the reflected wave by the TDR method is possible.

In FIG. 1, the second conductor layer 20 has a straight-line shape but is not limited to a particular shape as long as the shape covers a desired sensor region. For example, the second conductor layer 20 may have a meander shape as illustrated in a first embodiment, which will be described later, or may be in a shape having coarse portions and dense portions, in which dense regions are locally present as illustrated in a sixth embodiment.

The second conductor layer 20 may be formed by a similar method to the first conductor layer 10. For example, a linear shape may be obtained by performing a patterning process after a plating layer is formed. A patterning process method itself is not particularly limited as long as the process method is used in the field of electronics packaging. For example, a photo-lithography method is employed. In the photo-lithography method, for example, a resist layer is formed on a plating layer, light exposure and development are performed, and etching is then performed.

The dielectric layer 1 that has the first conductor layer 10 on the one surface and the second conductor layer 20 on the other surface may also be obtained by performing a similar patterning process to the above for a copper foil on one surface of a both-sided copper-clad laminate, which is commercially available. A both-sided copper-clad laminate is a laminate in which copper foils are attached to or formed on both sides of a polymer plate. The both-sided copper-clad laminate that has a desired elastic modulus particularly as the polymer plate may be selected from commercial products of such a both-sided copper-clad laminate and used,

The time-domain reflectometer 60 is usually formed with a signal input device, a reflected wave detection device, and a reflection time measurement device. Each of the signal input device and the reflected wave detection device is connected with the first conductor layer and the second conductor layer. Specifically, in a case where an anode side output terminal of the signal input device is connected with the first conductor layer 10, an anode side input terminal of the reflected wave detection device is similarly connected with the first conductor layer 10, and a cathode side output terminal of the signal input device and a cathode side input terminal of the reflected wave detection device are connected with the second conductor layer 20. Conversely, in a case where the anode side output terminal of the signal input device is connected with the second conductor layer 20, the anode side input terminal of the reflected wave detection device is similarly connected with the second conductor layer 20, and the cathode side output terminal of the signal input device and the cathode side input terminal of the reflected wave detection device are connected with the first conductor layer 10.

The reflection time measurement device is connected with the reflected wave detection device. Specifically, an anode terminal of the reflection time measurement device is connected with the anode side input terminal of the reflected wave detection device, and a cathode terminal of the reflection time measurement device is connected with the cathode side input terminal of the reflected wave detection device.

A signal input from the signal input device may have any waveform, and a step waveform, an impulse waveform, a square wave, a trapezoidal wave, and a triangle wave may be used, for example.

In FIG. 1, the second conductor layer 20 is exposed on the surface of the pressure sensor 100. However, as illustrated in a third embodiment, which will be described later, a dielectric layer 35 formed of an elastic body and a shield layer 40 may further be formed on surfaces of the second conductor layer 20 and the dielectric layer 1. Alternatively, a coating layer formed of an insulating material may be formed.

In FIG. 1, the pressure sensor 100 has only the second conductor layer 20 as the conductor layer, other than the first conductor layer 10. However, as illustrated in a second embodiment, which will be described later, a third conductor layer 30 as a linear wire may further be formed in a different main direction from the wire of the second conductor layer 20. In this case, as illustrated in a fifth embodiment, which will be described later, a shield layer 50 for blocking the electromagnetic and/or electrostatic interference between the second conductor layer 20 and the third conductor layer 30 may further be formed in second dielectric layer 25, 25A, and 25B.

The pressure sensor of the present disclosure has an easy and simple structure.

The pressure sensor of the present disclosure measures the reflected wave that is generated by elastic deformation of the dielectric layer by the stress from the outside, based on the TDR method, and thus does not cause malfunction without contact or malfunction due to unintended and incorrect contact.

The pressure sensor of the present disclosure performs measurement based on the magnitude and reflection time of the reflected wave that is generated by elastic deformation of the dielectric layer by the stress from the outside and may thus detect the magnitude of contact pressure as well as the position of contact.

The third conductor layer as a linear wire is further formed in a different main direction from the wire of the second conductor layer, and the detection accuracy may thereby be improved without setting a high frequency for an input signal.

The shield layer may be provided on the surface, and thereby the influence of disturbance (for example, an electromagnetic and/or electrostatic interference (noise)) may easily be blocked.

In the present disclosure, it is clear that in a case where time domain transmission method (hereinafter simply referred to as “TDT method”) is used instead of the TDR method, the magnitude and position of pressure may be measured by a similar configuration to the TDR method except the point that the signal input device is connected with one end of the second conductor layer 20 and a detection device and a time measurement device are connected with the other end and the point that a transmitted signal (transmitted wave) is observed instead of observation of the reflected wave.

Embodiments of the pressure sensor of the present disclosure will hereinafter be described more in detail.

### First Embodiment

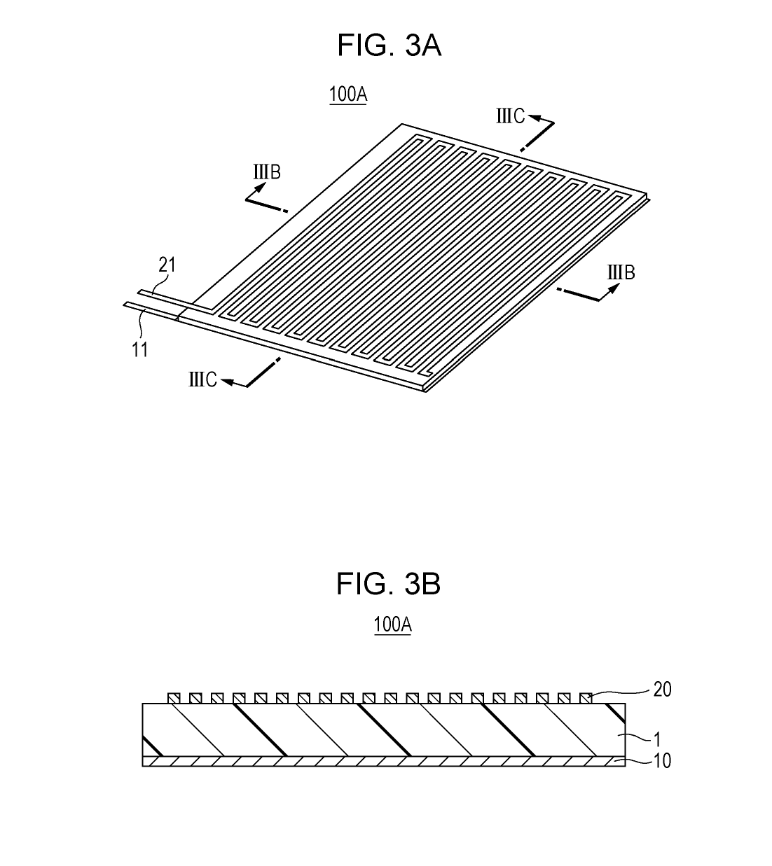

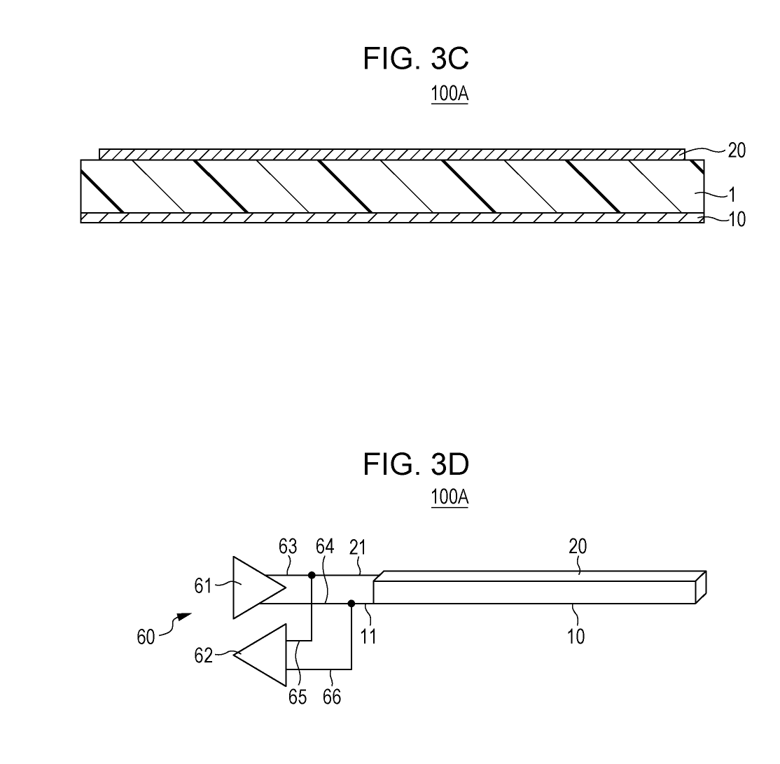

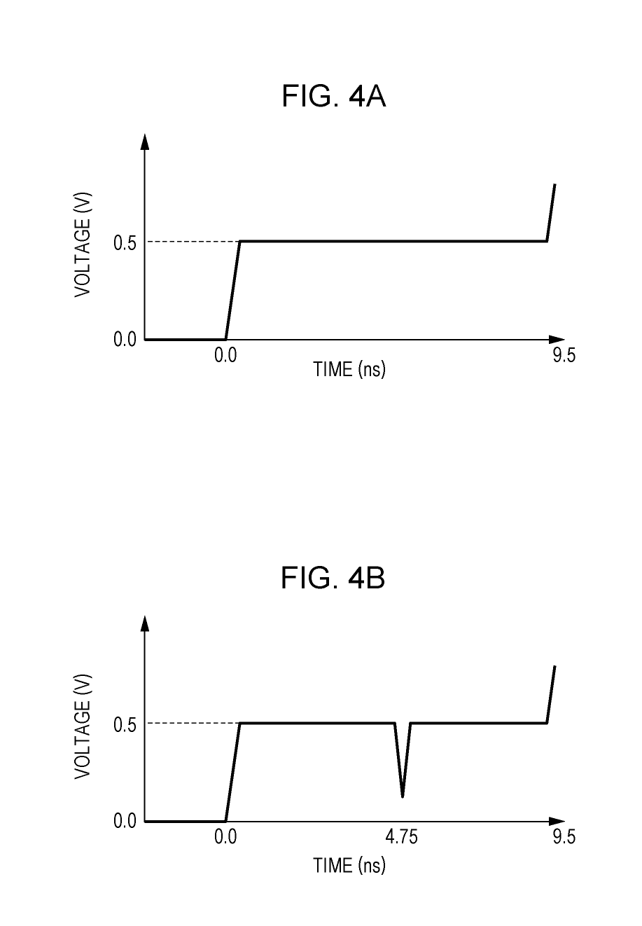

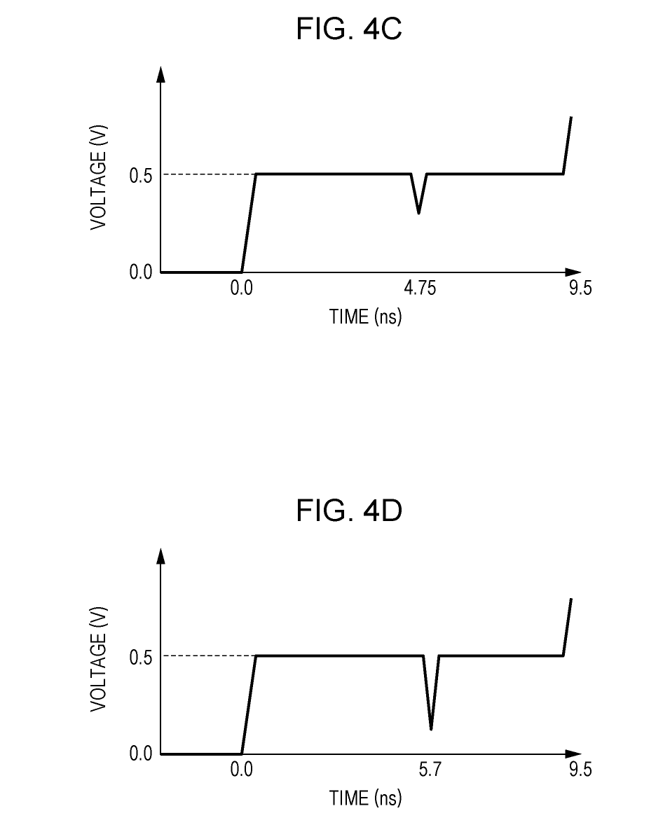

A pressure sensor 100A of this embodiment will be described with reference to FIGS. 3A to 3D and FIGS. 4A to 4D.

The pressure sensor 100A of this embodiment is configured to have the dielectric layer 1, the first conductor layer 10, the second conductor layer 20, and the time-domain reflectometer 60. In this embodiment, the first conductor layer 10 is formed on almost whole the surface, on which the first conductor layer 10 is formed, for example, whole the surface, and the second conductor layer 20 is formed as a meander-shaped wire. The pressure sensor 100A of this embodiment and configuration members thereof are similar to the above pressure sensor 100 and the configuration members thereof unless otherwise noted.

FIGS. 3A to 3D are diagrams that illustrate a structure of the pressure sensor 100A according to the first embodiment of the present disclosure. FIG. 3A is a perspective view of the pressure sensor 100A. FIG. 3B is a schematic cross-sectional view of IIIB-IIIB cross section of the pressure sensor 100A illustrated in FIG. 3A as seen in the arrow direction. FIG. 3C is a schematic cross-sectional view of IIIC-IIIC cross section of the pressure sensor 100A illustrated in FIG. 3A as seen in the arrow direction. FIG. 3D is a circuit configuration diagram in a case where a pressure is detected by using the pressure sensor 100A illustrated in FIG. 3A. The second conductor layer 20, the dielectric layer 1, and the first conductor layer 10 are laminated in this order so as to form a layer configuration.

In FIGS. 3A to 3D, the dielectric layer 1 is an elastic body formed of a silicone resin with a thickness of 1 mm×a vertical length of 20 cm×a horizontal length of 20 cm, and the same materials exemplified in the description of the dielectric layer 1 may be used. The second conductor layer 20 is a wire formed of copper with a thickness of 12 μm×a width of 2.8 mm×a length of 60 cm, and the same materials exemplified in the description of the second conductor layer 20 may be used. The first conductor layer 10 is a ground layer formed of copper with a thickness of 12 and the same materials exemplified in the description of the first conductor layer 10 may be used. A reflectometer 62 is formed with a reflected wave detection device and a reflection time measurement device, which are formed with semiconductor elements. A signal input device 61 formed of semiconductor elements and the reflectometer 62 configure the time-domain reflectometer 60. The second conductor layer 20 is connected with an anode side output terminal 63 of the signal input device 61 and an anode side input terminal 65 of the reflectometer 62 via a leader portion 21, and the first conductor layer 10 is connected with a cathode side output terminal 64 of the signal input device 61 and a cathode side input terminal 66 of the reflectometer 62 via a leader portion 11.

FIGS. 4A to 4D are diagrams that illustrate an operation of detecting a pressure by using the pressure sensor 100A in the first embodiment of the present disclosure. FIG. 4A is a graph that represents a change in voltage over time in a case where a pressure is not applied. FIG. 4B is a graph that represents the change in voltage over time in a case where a pressure is applied in a specific place. FIG. 4C is a graph that represents the change in voltage over time in a case where a different pressure is applied in the same place as FIG. 4B. FIG. 4D is a graph that represents the change in voltage over time in a case where the same pressure is applied in a different place from FIG. 4B.

The graphs in which the voltages measured by the reflectometer 62 in the configuration of FIGS. 3A to 3D are plotted along the time axis in a case where a step waveform at a voltage of 0.5 V is input from the signal input device 61 are FIGS. 4A to 4D.

FIG. 4A is a measurement result in a case where no stress is applied to the pressure sensor 100A, FIG. 4B is a measurement result in a case where a stress of 3 N is applied to a portion at 30 cm from the leader portion 21 of the second conductor layer 20. FIG. 4C is a measurement result in a case where a stress of 1.5 N is applied to the portion at 30 cm from the leader portion 21 of the second conductor layer 20. FIG. 4D is a measurement result in a case where a stress of 3 N is applied to a portion at 36 cm from the leader portion 21 of the second conductor layer 20.

In FIG. 4A, the thickness of the dielectric layer 1 does not change because no stress is applied. Thus, the distance between the second conductor layer 20 and the first conductor layer 10 may be considered as a transmission line having a regular impedance in every portion of the second conductor layer 20. Accordingly, in a case where a step signal is input from the signal input device 61 such that a voltage of 0.5 V is applied at a time 0 ns, the reflectometer 62 may measure a voltage of 0.5 V from the time 0.0 to 9.5 ns. The voltage exhibits a higher value than 0.5 V at the time 9.5 ns because a signal reflected by an end of the second conductor layer 20 on the opposite side from the leader portion 21 is measured. As described above, the reflected wave does not occur in a uniform transmission line, and the reflected wave that occurs in the impedance mismatching portion may be measured.

The fact that the reflected wave may be observed at the time 9.5 ns means that the time necessary for an electric signal to travel back and forth over a length of 30 cm of the second conductor layer 20 is 9.5 ns. The necessary time is determined by the dielectric constant and thickness of the dielectric layer 1, the wire width of the second conductor layer 20, and so forth.

Next, in a case where a stress of 3 N is vertically applied to the portion at 30 cm from the leader portion 21 in the second conductor layer 20, the dielectric layer 1 deforms due to the stress, and the thickness decreases. Thus, the distance between the second conductor layer 20 and the first conductor layer 10 becomes shorter, and the capacitance of this portion increases. This indicates that the impedance lowers, and reflection is generated in the impedance mismatching portion. A diagram that represents the situation is FIG. 4B. The lowered voltage at a time 4.75 ns indicates the occurrence of reflection in the impedance mismatching portion. It may be understood that the time is half the time of FIG. 4A and the stress is applied to a point at 30 cm from the leader portion 21 in the second conductor layer 20.

Further, a measured waveform in a case where a stress of 1.5 N is applied to the same portion as FIG. 4B is illustrated in FIG. 4C. It may be understood that the decrease amount of voltage is small compared to FIG. 4B. As described above, an applied stress may be measured by measuring the fluctuation range of voltage.

Further, a measurement result in a case where a stress of 3 N is applied to a more distant portion from the leader portion 21, which is at additional 6 cm from FIG. 4B, is illustrated in FIG. 4D. It may be seen that the time for the reflected wave to return becomes longer. As described above, which position of the second conductor layer 20 the stress is applied may be measured by measuring the time in which the reflected wave returns.

Further, the first conductor layer 10 is used as the shield layer, noise from the shield layer side may thereby be blocked, and higher measurement accuracy may be obtained.

In this embodiment, the number of wires that have to be connected with a measurement device or the like is two, which is less compared to a dozen or more of wires that are used for a common touch panel. Thus, a connector or the like that has less pins and is small in size, reasonable, and highly reliable may be used. Accordingly, small size, low price, and high reliability of an apparatus may be realized.

The step waveform of 0.5 V is used as the measured waveform. However, any of the above-described signal waveforms may be used. The voltage is not limited to this, but a higher or lower voltage may be used for obtaining desired electrical characteristics. In general, the S/N ratio is improved by using a high voltage, and high accuracy may be obtained. Further, use of a low voltage enables power consumption to be reduced and a high-speed semiconductor element to be used at a low price.

In this embodiment, one signal input device 61 and one reflectometer 62 are used. However, two or more signal input devices 61 and two or more reflectometers 62 may be used by switching the connections with the second conductor layer 20 and so forth by a switch. Accordingly, concurrent processing of measurement may be performed, and an increase in speed is achieved.

Further, the signal input device 61 and the reflectometer 62 are separately illustrated in the circuit. However, it is clear that those in a configuration with one semiconductor device operate with no change.

### Second Embodiment

In this embodiment, the third conductor layer as a linear wire is further formed in a different main direction from the wire of the second conductor layer, and the detection accuracy may thereby be improved.

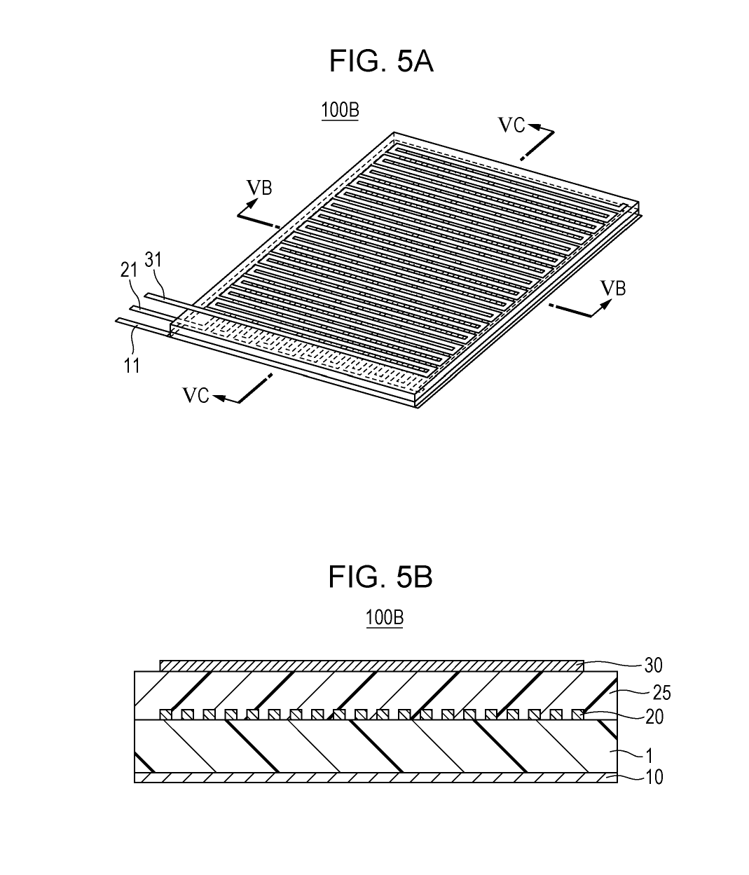

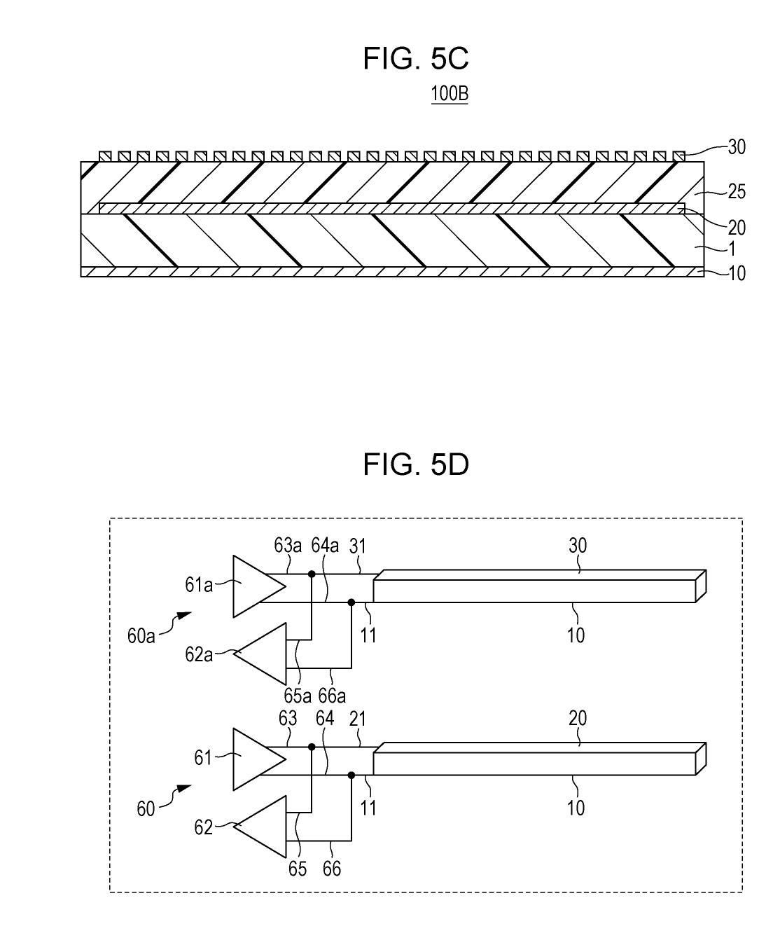

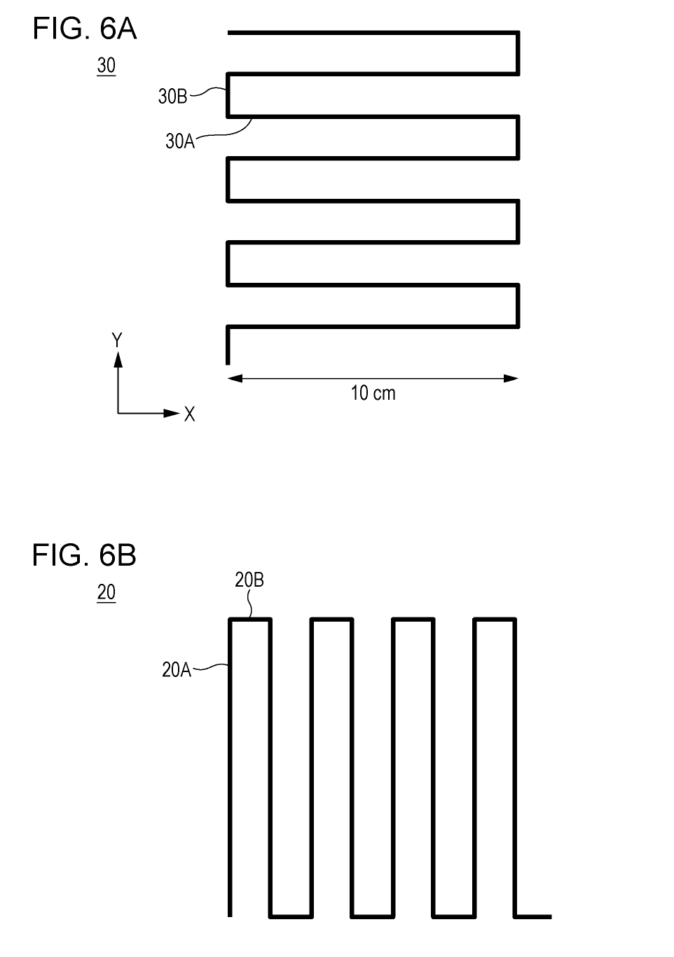

A pressure sensor 100B of this embodiment will be described with reference to FIGS. 5A to 5D and FIGS. 6A and 6B. FIGS. 5A to 5D are diagrams that illustrate a structure of the pressure sensor 100B in the second embodiment of the present disclosure. FIG. 5A is a perspective view of the pressure sensor 100B. FIG. 5B is a schematic cross-sectional view of VB-VB cross section of the pressure sensor 100B illustrated in FIG. 5A as seen in the arrow direction. FIG. 50 is a schematic cross-sectional view of VC-VC cross section of the pressure sensor 100B illustrated in FIG. 5A as seen in the arrow direction. FIG. 5D is a circuit configuration diagram in a case where a pressure is detected by using the pressure sensor 100B illustrated in FIG. 5A.

The pressure sensor 100B of this embodiment has a similar configuration to the pressure sensor 100A of the first embodiment except that the pressure sensor 100B has the second dielectric layer 25 and the third conductor layer 30 and has two time-domain reflectometers 60 and 60a. In the pressure sensor 100B of the second embodiment, the dielectric layer 1, the time-domain reflectometer 60, the signal input device 61, the reflectometer 62, the anode side output terminal 63, the cathode side output terminal 64, the anode side input terminal 65, and the cathode side input terminal 66 of the pressure sensor 100A of the first embodiment will be referred to as a first dielectric layer 1, a first time-domain reflectometer 60, a first signal input device 61, a first reflectometer 62, a first anode side output terminal 63, a first cathode side output terminal 64, a first anode side input terminal 65, and a first cathode side input terminal 66, respectively. The pressure sensor 100B of this embodiment and configuration members thereof are similar to the above pressure sensor 100A and the configuration members thereof unless otherwise noted.

The second dielectric layer 25 is a dielectric layer necessary for forming the third conductor layer 30. The second dielectric layer 25 is formed of an elastic body and formed on surfaces of the second conductor layer 20 and the first dielectric layer 1. The second dielectric layer 25 is similar to the above-described dielectric layer 1 and may be selected from the dielectric layer 1 to be independent from the dielectric layer 1. It is sufficient that the thickness of the second dielectric layer 25 is a thickness with which the second conductor layer 20 and the third conductor layer 30 do not contact with each other by a usual pressing force applied to the pressure sensor 100B. The second dielectric layer 25 may be formed by attaching a polymer material that is synthesized in advance by a known method to the surfaces of the second conductor layer 20 and the first dielectric layer 1 by an adhesive. Further, the second dielectric layer 25 may be formed by a formation method of a polymer layer, which is commonly used in the field of electronics packaging.

The third conductor layer 30 is formed as a meander-shaped wire on a surface of the second dielectric layer 25. The third conductor layer 30 is similar to the above-described second conductor layer 20 and may be selected from the second conductor layer 20 to be independent from the second conductor layer 20. The main direction of the wire of the third conductor layer 30 may be different from the main direction of the wire of the second conductor layer 20.

The time-domain reflectometer 60a corresponds to a second time-domain reflectometer. The second time-domain reflectometer 60a may have a similar configuration to the first time-domain reflectometer 60 and is usually formed with a second signal input device 61a, a second reflected wave detection device, and a second reflection time measurement device. A reflectometer 62a is formed with the second reflected wave detection device and the second reflection time measurement device. The second reflection time measurement device is connected with the second reflected wave detection device. The method of connecting the second signal input device, the second reflected wave detection device, and the second reflection time measurement device in the second time-domain reflectometer 60a is similar to the method of connecting the signal input device, the reflected wave detection device, and the reflection time measurement device in the above-described time-domain reflectometer 60.

A signal input from the second signal input device 61a may have any waveform, and examples may include the same waveform exemplified in the description of the first signal input device 61.

The second time-domain reflectometer 60a and the first time-domain reflectometer 60 may be shared, and one time-domain reflectometer may be used by switching the connections with the second conductor layer and the third conductor layer by a switch. That is, only one of the second time-domain reflectometer 60a and the first time-domain reflectometer 60 is used, and the used time-domain reflectometer may select the connection with the second conductor layer or the connection with the third conductor layer by a switch while maintaining the connection with the first conductor layer 10.

In FIGS. 5A to 5C, each of the first dielectric layer 1 and the second dielectric layer 25 is a silicone resin with a thickness of 1 mm×a vertical length of 20 cm×a horizontal length of 20 cm. The second conductor layer 20 and the third conductor layer 30 are wires formed of copper with a thickness of 12 μm×a width of 2.8 mm×a length of 60 cm. The first conductor layer 10 is a ground layer formed of copper with a thickness of 12 μm. The second conductor layer 20 and the third conductor layer 30 are respectively connected with anode side output terminals 63 and 63a of the different signal input devices 61 and 61a and anode side input terminals 65 and 65a of the different reflectometers 62 and 62a via leader portions 21 and 31. The first conductor layer 10 is connected with cathode side output terminals 64 and 64a of the different signal input devices 61 and 61a and cathode side input terminals 66 and 66a of the different reflectometers 62 and 62a via the leader portion 11. The third conductor layer 30, the second dielectric layer 25, the second conductor layer 20, the first dielectric layer 1, and the first conductor layer 10 are laminated in this order so as to form a layer configuration.

In the TDR method, the accuracy of detected position has a strong relationship with the frequency. One wavelength becomes long in a case where the frequency is low. This results in difficulty in detection of differences between the reflected waves that are reflected with short lengths with respect to one wavelength. Accordingly, the limit of the accuracy of detected position may be approximately 1/100 of a wavelength λ. Conversely, in order to detect a position with high accuracy, a signal at a short wavelength has to be used, that is, a signal at a high frequency has to be used. As for a step waveform and an impulse waveform, a frequency band f is expressed as tr=0.35/f by using a rise time tr. That is, a signal with a short rise time has to be used in order to increase the accuracy of detected position.

In this embodiment, the main wire directions of the second conductor layer 20 and the third conductor layer 30 are made different, and high accuracy of detected position may thereby be obtained with a slower rise time.

This principle will be described with reference to FIGS. 6A and 6B.

In FIGS. 6A and 6B, the reference numerals 30 and 20 schematically illustrate the third conductor layer and the second conductor layer, respectively. However, those actually overlap with each other in the thickness direction. The main direction of the meander-shaped wire of the third conductor layer 30 is an X axis, and the main direction of the meander-shaped wire of the second conductor layer 20 is a Y axis. That is, the second conductor layer 20 includes plural first straight line portions 20A that extend in the Y axis direction as the main direction and plural first connection portions 20B that are shorter than the plural respective first straight line portions 20A. Each of the plural first connection portions 20B connects ends of two neighboring first straight line portions 20A of the plural first straight line portions 20A. The third conductor layer 30 includes plural second straight line portions 30A that extend in the X axis direction as the main direction and plural second connection portions 30B that are shorter than the plural respective second straight line portions 30A. Each of the plural second connection portions 30B connects ends of two neighboring second straight line portions 30A of the plural second straight line portions 30A.

For example, in a case where detection accuracy of approximately 10 cm on the third conductor layer 30 is obtained by employing a frequency of approximately 100 MHz to 1 GHz, a position on the Y axis may be determined. Similarly, in a case where detection accuracy of approximately 10 cm on the second conductor layer 20 is obtained, a position on the X axis may be determined. As described above, the two wires whose main directions are different are used, and thereby a position on each of the X and Y axes may highly accurately detected by detection accuracy of approximately 10 cm.

Hypothetically, in order to obtain the same detection accuracy by using only the third conductor layer 30 (without using the second conductor layer 20), position accuracy in the X direction may not be obtained unless detection accuracy of approximately 0.1 cm on the third conductor layer 30 is obtained. That is, a signal with a 1/100 rise time has to be used.

In this embodiment, the two signal input devices 61 and 61a and the two reflectometers 62 and 62a are used. However, one signal input device 61 and one reflectometer 62 may be used by switching the connections with the second conductor layer 20 and the third conductor layer 30 by a switch.

Differently, three or more signal input device and three or more reflectometers are switched in use, and an increase in speed may be performed by concurrent processing of measurement.

Further, the signal input devices and the reflectometers are separately illustrated in the circuit. However, it is clear that those in a configuration with one semiconductor device operate with no change.

### Third Embodiment

In this embodiment, the shield layer is provided on a surface, and an electromagnetic and/or electrostatic interference (noise) from the outside may thereby be easily blocked. As a result, the detection accuracy may be improved.

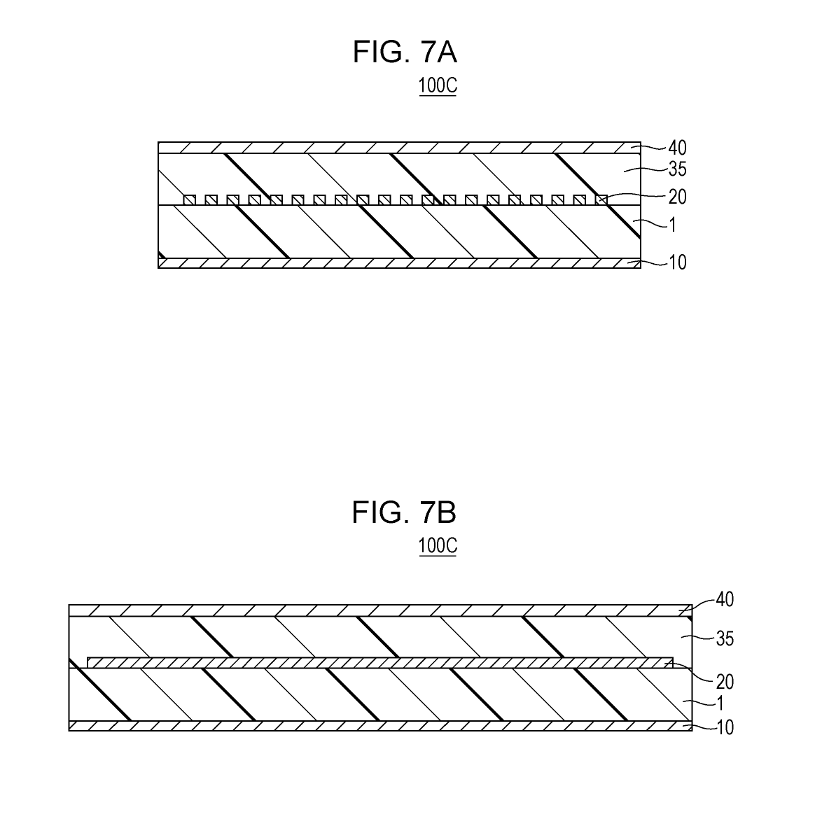

A pressure sensor 1000 of this embodiment will be described with reference to FIGS. 7A and 7B. FIG. 7A is a cross-sectional view of the pressure sensor 100C of this embodiment and is a schematic cross-sectional view of VB-VB cross section as seen in the arrow direction in a case where the pressure sensor 1000 of this embodiment is assumed as the pressure sensor illustrated in FIG. 5A. FIG. 7B is a cross-sectional view of the pressure sensor 1000 of this embodiment and is a schematic cross-sectional view of VC-VC cross section as seen in the arrow direction in a case where the pressure sensor 100C of this embodiment is assumed as the pressure sensor illustrated in FIG. 5A.

The pressure sensor 100C of this embodiment has a similar configuration to the pressure sensor 100A of the first embodiment except that the pressure sensor 1000 has a shield layer forming dielectric layer 35 and the shield layer 40. The pressure sensor 100C of this embodiment and configuration members thereof are similar to the above pressure sensor 100A and the configuration members thereof unless otherwise noted.

The shield layer forming dielectric layer 35 is a dielectric layer that is used for forming the shield layer 40. The shield layer forming dielectric layer 35 is formed of an elastic body and formed on the surfaces of the second conductor layer 20 and the first dielectric layer 1. The shield layer forming dielectric layer 35 is similar to the above-described dielectric layer 1 and may be selected from the dielectric layer 1 to be independent from the dielectric layer 1. It is sufficient that the thickness of the shield layer forming dielectric layer 35 is a thickness with which the second conductor layer 20 and the shield layer 40 do not contact with each other by a usual pressing force applied to the pressure sensor 1000. The shield layer forming dielectric layer 35 may be formed by a similar method to the second dielectric layer 25.

The shield layer 40 is not particularly limited as long as the shield layer 40 may block an electromagnetic and/or electrostatic interference (noise) from the outside. Examples of the shield layer 40 may include the same configuration materials exemplified in the description of the second conductor layer 20.

The shield layer 40 may be formed into a mesh in which sieve openings as in a net are provided or may be formed into a sheet in which the sieve openings are filled (that is, a configuration material is present on a substantially whole surface of a prescribed region). The shield layer 40 may be formed on whole the surface of the dielectric layer 1.

The thickness of shield layer 40 is not particularly limited as long as the shield layer 40 may block a noise.

In a case where the shield layer is not provided, the pressure sensor may be subject to a change in impedance due to an influence from the outside. For example, entrance of an electromagnetic wave from the outside causes entrance of a noise and so forth. Such influences may be reduced in a case where the shield layer is provided.

Specifically, the pressure sensor of the first embodiment may use a back surface (the first conductor layer 10) as the shield layer, for example. In a case where the shield layer is used on a front surface of an apparatus, it is possible to reduce the influence of disturbance from the front surface, but it is difficult to reduce disturbance from the back surface side (the apparatus side). Particularly, it is difficult to reduce entrance of noises due to operations of circuits of the apparatus. On the other hand, in a case where the shield layer is provided on the back surface side and a wire layer (the second conductor layer 20) is arranged on the front surface, it is difficult to reduce an influence from the outside of the apparatus.

In this embodiment, the first conductor layer 10 on the back surface is used as the shield layer, and the shield layers are thereby provided on both of the surfaces of the pressure sensor. Thus, the pressure sensor 100C of this embodiment may have protection from both of noises from the inside of the apparatus and noises from the outside of the apparatus, the accuracy of the pressure sensor is improved, and an improvement in sensitivity may be expected. An improvement of 3 dB in the S/N ratio was observed in the comparison between actual cases where the shield layer was arranged only on the back surface side and where the shield layers were arranged on both of the surfaces.

### Fourth Embodiment

In this embodiment, the third conductor layer as a linear wire is further formed in a different main direction from the wire of the second conductor layer, and the shield layer is provided on a surface. Accordingly, the detection accuracy may further and sufficiently be improved.

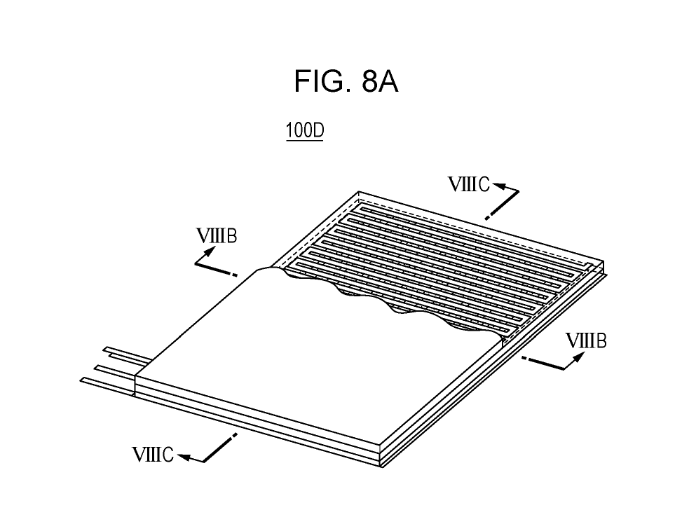

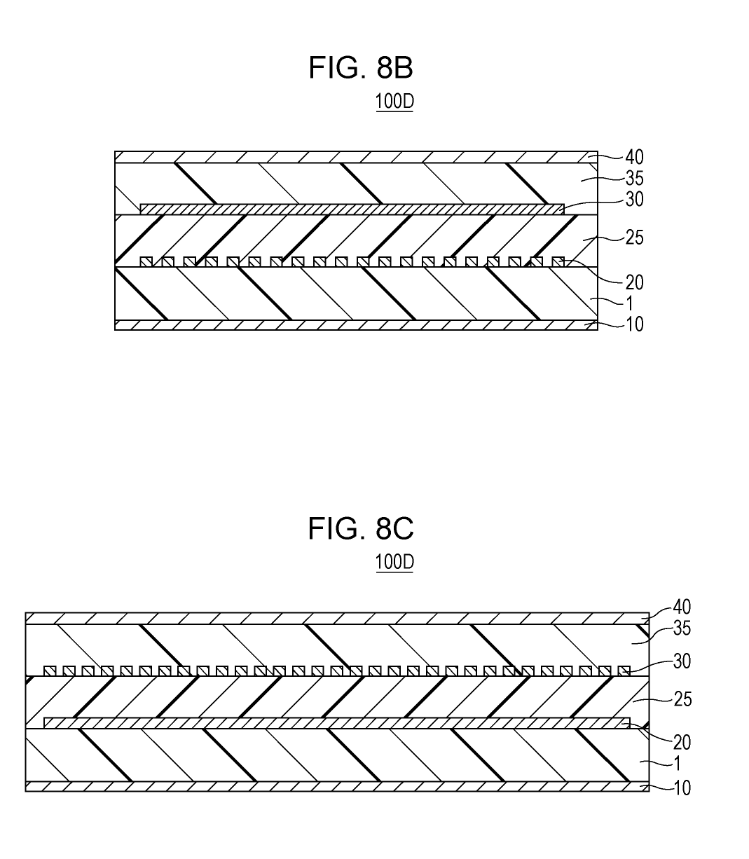

A pressure sensor 100D of this embodiment will be described with reference to FIGS. 8A to 8C. FIG. 8A is a perspective view of the pressure sensor 100D. FIG. 8B is a schematic cross-sectional view of VIIIB-VIIIB cross section of the pressure sensor 100D illustrated in FIG. 8A as seen in the arrow direction. FIG. 8C is a schematic cross-sectional view of VIIIC-VIIIC cross section of the pressure sensor 100D illustrated in FIG. 8A as seen in the arrow direction.

The pressure sensor 100D of this embodiment has a similar configuration to the pressure sensor 100B of the second embodiment except that the pressure sensor 100D has the shield layer forming dielectric layer 35 and the shield layer 40. The pressure sensor 100D of this embodiment and configuration members thereof are similar to the above pressure sensor 100B and the configuration members thereof unless otherwise noted.

The shield layer forming dielectric layer 35 of this embodiment is similar to the shield layer forming dielectric layer 35 of the third embodiment except that the shield layer forming dielectric layer 35 is formed on surfaces of the third conductor layer 30 and the second dielectric layer 25. It is sufficient that the thickness of the shield layer forming dielectric layer 35 of this embodiment is a thickness with which the third conductor layer 30 and the shield layer 40 do not contact with each other by a usual pressing force applied to the pressure sensor 100D.

The shield layer 40 of this embodiment is similar to the shield layer 40 of the third embodiment.

### Fifth Embodiment

In this embodiment, the shield layer 50 is provided between the second conductor layer 20 and the third conductor layer 30, and the electromagnetic and/or electrostatic interference (noise) between the second conductor layer 20 and the third conductor layer 30 may thereby be easily blocked. As a result, the detection accuracy may be improved.

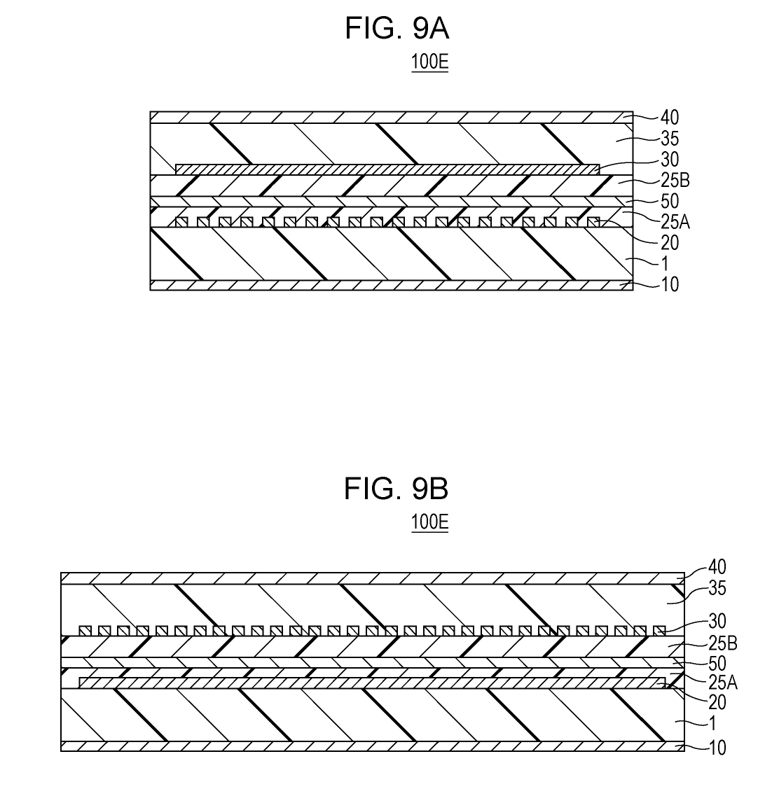

A pressure sensor 100E of this embodiment will be described with reference to FIGS. 9A and 9B. FIG. 9A is a cross-sectional view of the pressure sensor 100E of this embodiment and is a schematic cross-sectional view of VIIIB-VIIIB cross section as seen in the arrow direction in a case where the pressure sensor 100E of this embodiment is assumed as the pressure sensor illustrated in FIG. 8A. FIG. 9B is a cross-sectional view of the pressure sensor 100E of this embodiment and is a schematic cross-sectional view of VIIIC-VIIIC cross section as seen in the arrow direction in a case where the pressure sensor 100E of this embodiment is assumed as the pressure sensor illustrated in FIG. 8A.

The pressure sensor 100E of this embodiment has a similar configuration to the pressure sensor 100D of the fourth embodiment except that the pressure sensor 100E further has the shield layer 50 in the second dielectric layers 25A and 25B. The pressure sensor 100E of this embodiment and configuration members thereof are similar to the above pressure sensor 100D and the configuration members thereof unless otherwise noted.

The shield layer 50 of this embodiment is similar to the shield layer 40 of the third embodiment except that the electromagnetic and/or electrostatic interference (noise) between the second conductor layer 20 and the third conductor layer 30 is blocked.

Each of the second dielectric layers 25A and 25B of this embodiment is similar to the second dielectric layer 25 of the second embodiment. It is sufficient that the thicknesses of the second dielectric layers 25A and 25B are thicknesses with which contact between the second conductor layer 20 and the shield layer 50 and contact between the shield layer 50 and the third conductor layer 30 do not occur by a usual pressing force applied to the pressure sensor 100E.

### Sixth Embodiment

In this embodiment, a pressure sensor having a much easier structure may be obtained by devising the shape of the second conductor layer 20 (wire).

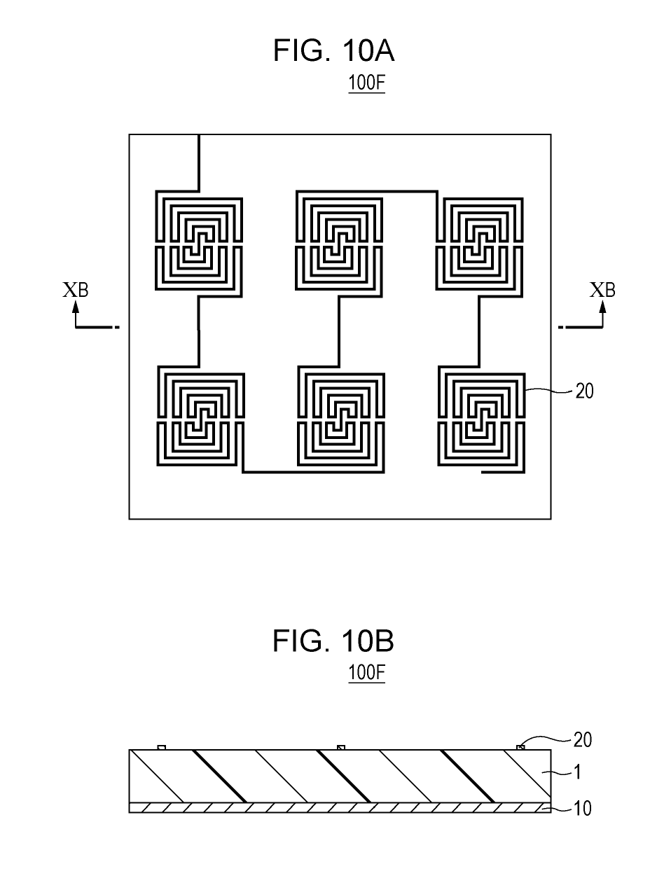

A pressure sensor 100F of this embodiment will be described with reference to FIGS. 10A and 10B. FIG. 10A is a top view of the pressure sensor 100F of this embodiment. FIG. 10B is a schematic cross-sectional view of XB-XB cross section of the pressure sensor 100F illustrated in FIG. 10A as seen in the arrow direction.

The pressure sensor 100F of this embodiment has a similar configuration to the pressure sensor 100A of the first embodiment except that the shape of the second conductor layer 20 is formed in a shape as illustrated in FIG. 10A. The pressure sensor 100F of this embodiment and configuration members thereof are similar to the above pressure sensor 100A and the configuration members thereof unless otherwise noted.

As illustrated in FIG. 10A, the shape of the second conductor layer 20 of this embodiment is a shape having coarse portions and dense portions, in which dense regions of the second conductor layer 20 are locally present. Such dense regions are used as discriminating areas (button areas) of a touch panel or the like, and a pressure on plural buttons may thereby be detected by one wire and one time-domain reflectometer.

The second conductor layer 20 of this embodiment is similar to the second conductor layer 20 of the first embodiment except the shape as the whole is different.

Each of the dielectric layer 1 and the first conductor layer 10 of this embodiment are similar to the dielectric layer 1 and the first conductor layer 10 of the first embodiment.

The pressure sensor 100F of this embodiment is useful particularly for operating switches of home appliances (such as a hot water dispenser, a microwave oven, and IH cookware).

The pressure sensor 100F has the wire structure illustrated in FIG. 10A, and a pressure applied to each of the discriminating areas may thereby be sensed even in a case where a signal with a slow rise time is used. This is because a long wire length may be provided between one discriminating area and another discriminating area and sufficient position resolution may be obtained even in a case where the frequency of the TDR is low and/or the rise time is slow.

### Embodiment of Transparent Pressure Sensing Element

Such an embodiment is an embodiment in which a pressure sensor is transparent. In such an embodiment, at least one of the dielectric layer 1, the first conductor layer 10, and the second conductor layer 20 has optical transparency. That is, at least one of the configuration elements of the pressure sensor is transparent in the visible light region.

All the configuration elements of the pressure sensor may be transparent elements. That is, all of the dielectric layer 1, the first conductor layer 10, and the second conductor layer 20 may have optical transparency. The second dielectric layer 25, the third conductor layer 30, the shield layer forming dielectric layer 35, the shield layer 40, and the shield layer 50 may also have optical transparency.

The above configuration elements of the pressure sensors 100 and 100A to 100F of the present disclosure have the following material characteristics to secure transparency, for example.

The conductor layers (for example, the first conductor layer 10, the second conductor layer 20, and the third conductor layer 30) may have a form of a transparent conductor layer. The transparent conductor layer may include a transparent conducting material such as ITO.

The shield layers (for example, the shield layer 40 and the shield layer 50) may have a form of a transparent shield layer. The transparent shield layer may include a transparent conducting material such as ITO.

The dielectric layers (for example, the dielectric layer 1, the dielectric layer 25, the dielectric layer 25A, the dielectric layer 25B, and the dielectric layer 35) may have a form of a transparent dielectric layer. The dielectric layer may include a transparent dielectric material such as a transparent resin. Examples of dielectric materials of transparent resins may include polyethylene terephthalate resins and/or polyimide resins.

### [Pressure Sensing Device]

The present disclosure may be provided to any pressure sensing device that includes the above pressure sensors.

The above pressure sensor 100 (including 100A to 100F) of the present disclosure itself has characteristics that the pressure sensor 100 itself is a flat plate that has flexibility, has a one-dimensional wire, and has a small amount of leader wire. Utilizing those characteristics, the pressure sensor 100 itself of the present disclosure may be bent and curved into various shapes and processed into a pressure sensing device. The pressure sensor 100 of the present disclosure is attached to a flexible supporting body, and the obtained flexible material is bent and curved into various shapes and may thereby be processed into a pressure sensing device. Thus, the pressure sensor of the present disclosure and the pressure sensing device that includes the pressure sensor are useful as a flexible pressure sensor and a flexible pressure sensing device. Flexibility is a characteristic that an object bends to deform due to external force and returns to an original shape when the force is removed.

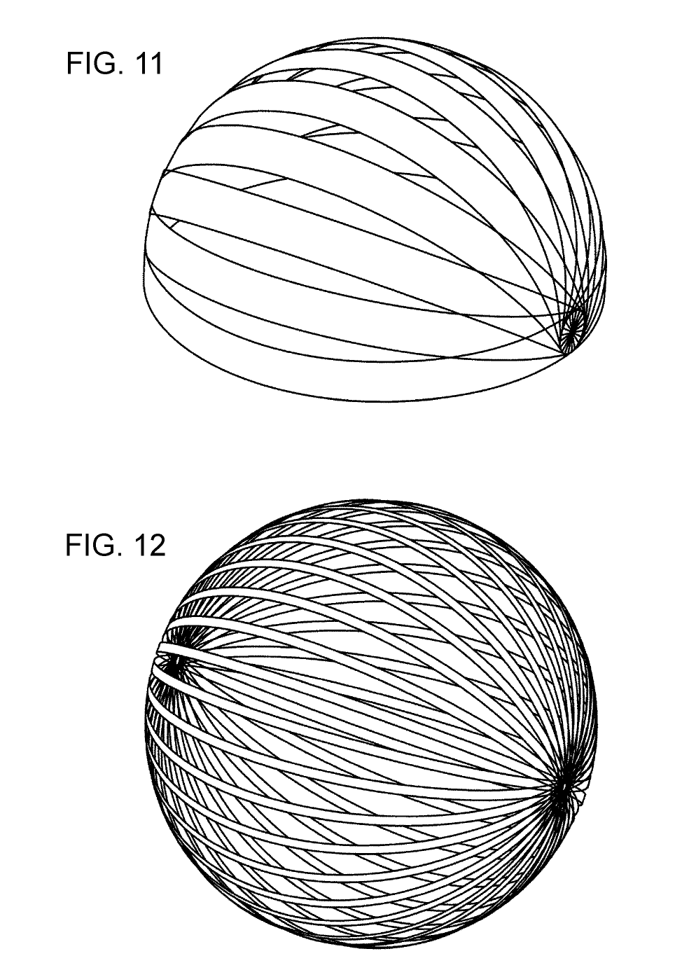

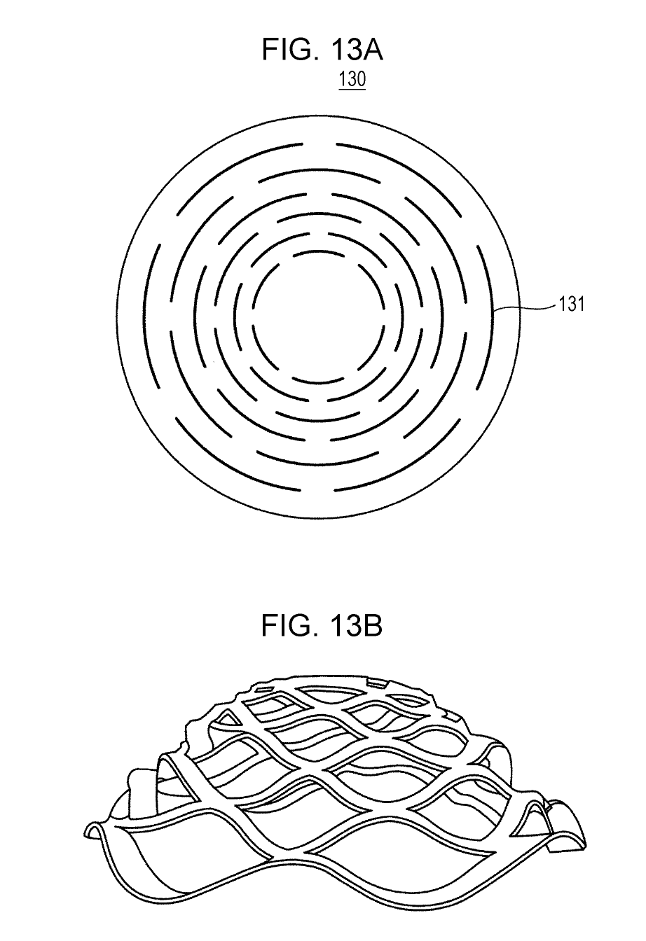

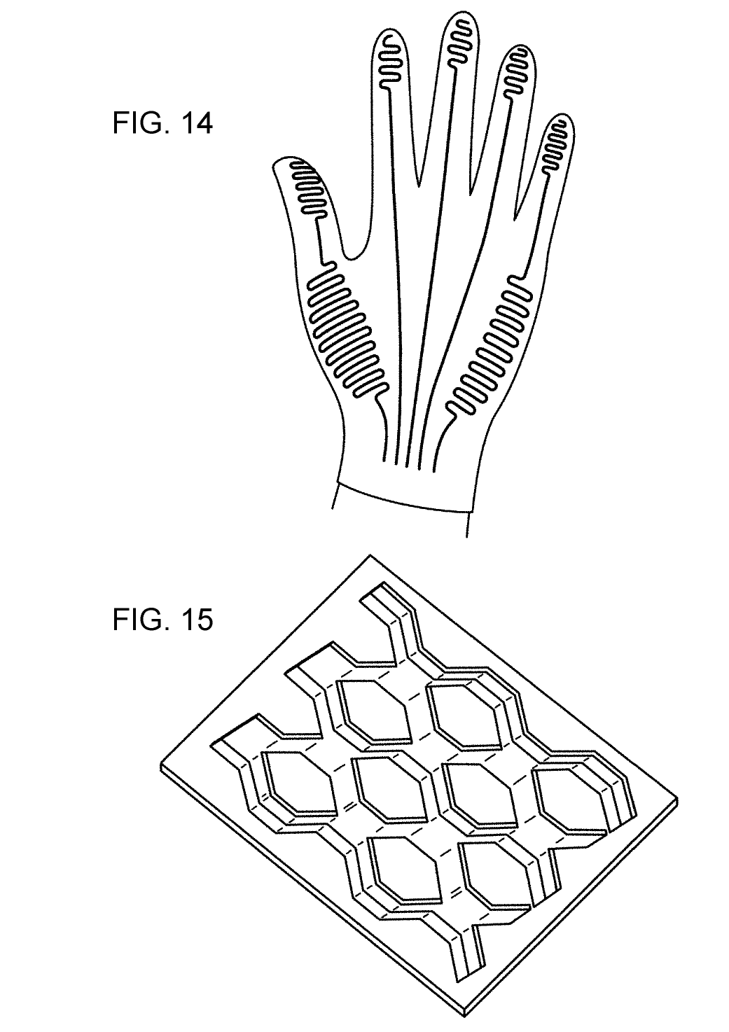

Examples of shapes possible with the pressure sensing device of the present disclosure may include a semi-spherical shape illustrated in FIG. 11, a spherical shape illustrated in FIG. 12, a conical shape illustrated in FIGS. 13A and 13B, a glove shape illustrated in FIG. 14, a stretchable flat plate shape illustrated in FIG. 15, and combined shapes of those.

The shapes illustrated in FIGS. 11, 12, 13A and 13B, 14, and 15 may be formed by providing appropriate slits in a flexible material that includes the pressure sensor of the present disclosure. For example, FIG. 13A illustrates a circular flexible material 130 that has slits 131. FIG. 13B is a sketch of a solid conical shape that is formed when a central portion of the flexible material illustrated in FIG. 13A is picked up. Further, for example, FIG. 14 illustrates an external shape of a glove formed by sewing the flexible material in a case where the flexible material that includes the pressure sensor of the present disclosure has further flexibility.

A coating process or an embedding process with an insulating material may be applied to the pressure sensor and the pressure sensing device of the present disclosure. For example, FIG. 15 illustrates one example of a pressure sensing device in which a flat plate made stretchable by providing appropriate slits in the flexible material that includes the pressure sensor of the present disclosure is embedded in an insulating polymer material.

Further, in view of the configuration, it is clear that the shapes are not limited to those illustrated in FIGS. 11 to 15 but a pressure distribution measurement is possible by various shapes.

The embodiments of the present disclosure have been described in the foregoing. Persons having ordinary skill in the art easily understand that the present disclosure is not limited to the above embodiments but various modifications are possible.

What is claimed is:

1. A pressure sensor comprising;
a first dielectric layer that has elasticity and has a first surface and a second surface which is on an opposite side from the first surface;
a first conductor layer that is arranged on at least a region of the first surface;
a second conductor layer that is arranged on the second surface; and
a first time-domain reflectometer that is connected with the first conductor layer and the second conductor layer, wherein
the region of the first surface is opposed to the second conductor layer.

2. The pressure sensor according to claim 1, wherein the first conductor layer has a mesh shape or a sheet shape.

3. The pressure sensor according to claim 1, wherein, in operation,
the first time-domain reflectometer
inputs a first signal to the first conductor layer and the second conductor layer when a stress from an outside is applied to at least a portion of the first dielectric layer, and
measures a magnitude of a first reflected wave that is generated by reflection of the first signal by the at least portion of the first dielectric layer and a first reflection time that is a time from the input of the first signal to the first conductor layer and the second conductor layer to arrival of the first reflected wave to the first time-domain reflectometer.

4. The pressure sensor according to claim 1, wherein
the first time-domain reflectometer includes
a first signal input device that, in operation, inputs a first signal to the first conductor layer and the second conductor layer,
a first reflected wave detection device that, in operation, detects a first reflected wave that is generated by reflection of the first signal by at least a portion of the first dielectric layer, and
a first reflection time measurement device that, in operation, measures a first reflection time that is a time from an input of the first signal to the first conductor layer and the second conductor layer to arrival of the first reflected wave to the first time-domain reflectometer.
each of the first signal input device and the first reflected wave detection device is connected with the first conductor layer and the second conductor layer, and
the first reflection time measurement device is connected with the first reflected wave detection device.

5. The pressure sensor according to claim 1, wherein
the first conductor layer covers a whole surface of the first surface, and
the second conductor layer has a meander shape.

6. The pressure sensor according to claim 1, further comprising:
a second dielectric layer that is arranged on the second conductor layer and on the second surface of the first dielectric layer and has elasticity; and
a shield layer that is arranged on the second dielectric layer and has conductivity.

7. The pressure sensor according to claim 1, further comprising:
a second dielectric layer that is arranged on the second conductor layer and on the second surface of the first dielectric layer and has elasticity; and
a third conductor layer that is arranged on the second dielectric layer.

8. The pressure sensor according to claim 7, wherein the second conductor layer and the third conductor layer have meander shapes.

9. The pressure sensor according to claim 8, wherein
the second conductor layer includes first straight line portions that extend in a first direction and first connectors that are shorter than each of the first straight line portions,
each of the first connectors connects ends of two neighboring first straight line portions of the first straight line portions,
the third conductor layer includes second straight line portions that extend in a second direction which is different from the first direction and second connectors that are shorter than each of the second straight line portions, and
each of the second connectors connects ends of two neighboring second straight line portions of the second straight line portions.

10. The pressure sensor according to claim 7, further comprising:
a second time-domain reflectometer that is connected with the first conductor layer and the third conductor layer.

11. The pressure sensor according to claim 10, wherein
the second time-domain reflectometer includes
a second signal input device that, in operation, inputs a second signal to the first conductor layer and the third conductor layer,
a second reflected wave detection device that, in operation, detects a second reflected wave that is generated by reflection of the second signal by at least a portion of the first dielectric layer and the second dielectric layer, and
a second reflection time measurement device that, in operation, measures a second reflection time that is a time from an input of the second signal to the first conductor layer and the third conductor layer to arrival of the second reflected wave to the second time-domain reflectometer,
each of the second signal input device and the second reflected wave detection device is connected with the first conductor layer and the third conductor layer, and
the second reflection time measurement device is connected with the second reflected wave detection device.

12. The pressure sensor according to claim 7, further comprising:
a switch that is arranged between the first time-domain reflectometer and the second conductor layer and, in operation, switches states between a state where the first time-domain reflectometer is connected with the second conductor layer and a state where the first time-domain reflectometer is connected with the third conductor layer.

13. The pressure sensor according to claim 7, further comprising:
a third dielectric layer that is arranged on the third conductor layer and on the second dielectric layer on which the third conductor layer is arranged and has elasticity; and
a shield layer that is arranged on the third dielectric layer and has conductivity.

14. The pressure sensor according to claim 7, further comprising:
a shield layer that is arranged in the second dielectric layer and has conductivity.

15. The pressure sensor according to claim 1, wherein at least one selected from the group of the first conductor layer and the second conductor layer includes indium tin oxide.

16. The pressure sensor according to claim 1, wherein the first dielectric layer includes a transparent resin.
